(19) United States
(12) Patent Application Publication
(10) Pub. No.: US 2012/0240474 A1
(43) Pub. Date: Sep. 27, 2012

(54) APPARATUS FOR CONTROLLING THE MOVEMENT OF A CLOSURE

(75) Inventor: Neil Kenneth Williams Purssey, Brighton (GB)

(73) Assignee: Fireco LImited, Brighton (GB)

(21) Appl. No.: 13/319,438

(22) PCT Filed: May 10, 2010
(86) PCT No.: PCT/GB2010/000948

§ 371 Date: Jun. 19, 2012

(30) Foreign Application Priority Data
May 8, 2009 (GB) 0907954.2

(51) Int. Cl. E05C 19/16; E05F 3/22

(52) U.S. Cl. 49/506; 292/251.5

(57) ABSTRACT

According to the present invention there is provided a catch device (21) for use in controlling the movement of a closure, the device comprising: first and second magnetic elements (5, 6) spaced apart from each other; and a movable element (9) such as a keeper element, preferably arranged relative to the magnetic elements, the movable element being movable between first and second holding positions wherein in the first holding position the movable element (9) is held by a magnetic force of the first magnetic element (5) and in the second holding position the movable element (9) is held by a magnetic force of the second magnetic element (6); and means (12) for releasing the movable element from one of the holding positions, the released movable element moving to the other holding position, the device being such that the movement of the closure can be controlled in dependence on the position of the movable element.

This invention relates to valve apparatus, catch devices and closures, as well as to a method of controlling the movement of a closure. Aspects of the invention relate to valve apparatus for controlling the flow of fluid, and apparatus for controlling the movement of a closure, and in particular to the opening and closing of a closure. Particular examples described relate to the controlling of the opening and closing of doors. However, it will be understood that some aspects and features will be applicable to other closures, for example windows, as well as other closures such as hatches, fences, cupboard doors etc.

This invention finds particular, but not exclusive, application in the control of the holding open and closing of doors such as fire doors, for example in the event of a fire alarm being raised.

Fire doors are designed to provide a barrier to fire and are designed to withstand the heat and other environmental conditions of fire and to hinder the spread of the fire and its products such as smoke and other gases. As such, if a fire breaks out, it is important that the fire door be closed so that it can fulfil its function. To this end, most fire doors are fitted with a door closer which acts to bias the door to the closed position. A common type of door closer is mounted at the top of the door arrangement, a first part being fixed to the door, another part to the door frame. The door closer includes a biasing member which acts to bias the door to a closed position. The door closer is such that the door can be opened on application of an opening force, but once the opening force is released the door swings closed as the biasing member acts to return the door to its closed position.

While closed fire doors are essential in the event of a fire, at other times, in particular where the door is in an area of high traffic, the need to open the door to pass through the doorway is often inconvenient. Historically, this has led the dangerous practice of propping open fire doors (ironically often using a fire extinguisher).

In response to this problem, many fire doors are additionally fitted with a door holder device which acts to hold the door in an open position. For safety reasons, such door holder devices are adapted so that they release the door at an appropriate time, for example in the event of an alarm, such as a fire alarm, being raised, or at night when the building is less occupied, or other appropriate time. Devices are available which can detect that a condition exists that requires the closing of the door, for example that an alarm condition exists, and can automatically release the door. An example of such a door opener is the DORGARD door opener of Fireco Limited, features of which are described in International Patent Application No. 93/20317.

Thus some doors may be provided with both a door closer and a door opener. In other arrangements, attempts have been made to integrate the function of a door closer and door opener together. In particular, there are known door closers which allow a door to be held open against the biasing force of the door closer mechanism, and subsequently automatically effect closure of the door at an appropriate time, for example in the event of a fire or other emergency by allowing the biasing force of the door closer to act on the door to close it. For example, UK Patent Application No. GB2183290A describes such a mechanism. GB2183290A describes a door closure having a biasing member for urging the door to the closed position. A catch mechanism is provided which acts to hold the door in an open position, the arrangement being that in the event of a fire, movement of the catch is effected so that the door is released and swings closed. The catch mechanism operates by retaining a steel keeper disc using an electromagnet. This electromagnet is maintained in a powered state to retain the keeper disc so that the door can be held open. In the event of a fire or power failure, the electromagnet releases the keeper disc and the door closer acts to close the door.

However, it is seen that this arrangement is not energy efficient and is such that the device requires a mains power source. It is also seen that the device of GB2183290A is mechanically complex.

It would be desirable to provide an energy efficient door closer which is safe and reliable in operation and which preferably solves or at least mitigates one or more of the problems indicated above and/or other problems of existing door opener/closer arrangements.

According to a first aspect of the invention, there is provided a catch device for use in controlling the movement of a closure, the device comprising: first and second magnetic elements preferably spaced apart from each other; and a movable element such as a keeper element preferably arranged relative to the magnetic elements, the movable element being movable between first and second holding positions wherein in the first holding position the movable element is held by a magnetic force of the first magnetic element and in the second holding position the movable element is held by a magnetic force of the second magnetic element; and means for releasing the movable element from one of the holding positions, the released movable element moving to the other holding position, the device being such that the movement of the closure can be controlled in dependence on the position of the movable element.

The first and second magnetic elements may be pole portions of one or more permanent magnets. For example, the first and second magnetic elements may be the north and south poles of a single permanent magnet, or the south poles of two different magnets, or the north poles of two different magnets. The first magnetic element may comprise one pole of the magnet and a first electromagnet, and the second magnetic element may comprise the other pole of the magnet and a second electromagnet.

As used herein, the terms “movable element” and “keeper element” may be used interchangeably.

By arranging for the movable element to be held in the first position and then held in the second position depending on the state of the device, a bistable device can be provided. This can lead to advantages. In particular, in some examples, actuation of the magnet device is required to move the device between states. This can have safety benefits.

Preferably the device is adapted for interaction with an element of a device for controlling the movement of a closure.

Preferably the device includes means for controlling the movement of the closure in dependence upon the position of the movable element.

Preferably the device can control retaining or release of the closure in dependence on the position of the movable element.

The movement of the movable element may be adapted to change the state of the device from a closure retaining state to a closure release state.

The closure may be a door. The device may be adapted for use in relation with a door retainer, or a door closure/retaining device. However, the catch device has potentially broader application.

According to a broad aspect of the invention there is provided a catch device, the device comprising: first and second magnetic elements spaced apart from each other; and a movable element arranged relative to the magnetic elements, the movable element being movable between first and second holding positions wherein in the first holding position the movable element is held by a magnetic force of the first magnetic element and in the second holding position the movable element is held by a magnetic force of the second magnetic element; and means for releasing the movable element from one of the holding positions, the released movable element moving to the other holding position,

the device being in a retaining state or a releasing state in dependence on the position of the movable element.

The movable element is preferably arranged between the magnetic elements.

Preferably the distance between the magnet elements and the magnetic force is such that when the movable element is released by one magnetic element, it is attracted to another magnetic element.

Examples of the invention have been described herein in relation to the use of two magnetic elements. It is envisaged that more than two magnetic elements may be present. The device may have more than two equilibrium states.

The movable element may conveniently include ferrous material; if it does not contain ferrous material it may act merely as a control element which is not itself attracted by the magnetic elements.

The movable element may include an electromagnet.

The movable element may include one or more keeper plates, the keeper plate being adapted to be held to the magnetic element by a magnetic force.

The magnetic element may include a permanent magnet. In this way, the movable element can be held to the magnet element and a release action is required to release the movable element from the magnet element to change the state of the device.

Preferably, said permanent magnet is arranged to hold said movable element in said first or second holding position and wherein the movable element release means is operable to release said movable element from said first or second holding position by overwhelming said permanent magnet. More preferably, said movable element is released from said first or second holding position when said electromagnet is energised.

The device preferably further includes an actuator to release the movable element from one of the holding positions to the other holding position. The actuator may include an electromagnet.

The magnetic element may include an electromagnet. The device may include means for applying a signal to an actuator to effect the release of the movable element.

The device may include means for applying a current to the magnet element to effect the release of the movable element. More preferably, said current is applied for a period of time sufficient to release said movable element and wherein after said movable element is released said current is stopped.

Preferably, said movable element is retained in said first or second holding position without requiring the application of an electric current.

In preferred arrangements, current need only be applied to release the element to change the state of the device. When the movable element is held at the magnetic element, preferably no current is applied.

In a preferred arrangement the magnetic element includes a permanent magnet having a surrounding coil to which current can be applied. The application of current to the coil can effectively demagnetise the magnetic element.

Other ways may be used to effectively “demagnetise” the magnetic element so that the movable element is released. For example, movement of the permanent magnet may allow the release of the movable element.

The magnetic elements and movable element may be mounted in a common housing.

The actuator may be in a common assembly with the movable element.

Each of the first and second magnetic elements may be associated with a separate actuator part, said actuator parts may be actuable independently of each other.

The parts may be arranged to be actuated simultaneously, for example in a mutually opposing sense.

The device may further include a controller for controlling the release of the movable element from a magnetic element.

Preferably the controller is adapted to control the actuation of the actuator.

The device may further include a power supply. The power supply may include one or more battery units.

The controller may be adapted to detect an alarm condition and effect the movement of the movable element to a release position.

The device may further include a sensor for sensing an alarm condition.

The device may further include a receiver for receiving a signal indicating an alarm condition.

The device could be connected to a safety device, for example the control panel of a fire system.

The connection could be wireless.

The device may further include a receiver for receiving an alarm signal transmitted into the ambient medium.

The signal could include for example a radio frequency signal and/or an acoustic signal.

The device may further include an acoustic sensor.

The device may also trigger on the identification of a safety issue, for example a low battery, or power supply failure.

A further aspect of the invention provides apparatus for retaining a closure, the apparatus including means for retaining the closure, and further including a catch device described herein.

Also provided by the invention is a door closer/retainer apparatus including a catch device described herein.

Also provided by the invention is a method of controlling the movement of a closure using a device comprising a closure movement apparatus for moving the closure from a first position to a second position, and retaining means for retaining the closure in one of the first and second positions, the device further including a catch described herein, the method including the steps of: identifying an alarm condition and releasing the movable element from a holding position such that the released movable element moves to a holding position such that the retaining means releases the closure.

Preferred examples of the invention may provide a closure retaining/closing device which can allow a door or other closure to be retained in an open position, but will release the door so that it closes in response to an alarm condition or other trigger. Examples of the invention provide a catch for use in such a device. Preferably the apparatus does not require power to be applied to the device when in an equilibrium position, preferably power only being required to switch the device between retaining and releasing states.

According to a broad aspect of the invention there is provided apparatus for controlling movement of a closure, including a catch device for switching the apparatus between a closure retaining state and a closure releasing state, the apparatus including means for supplying current to the catch device to switch the apparatus between the retaining and releasing states.

Preferably no current is required to hold the apparatus in the retaining or releasing state, thus saving energy.

Preferably the catch is adapted to fail to safe by moving the catch into a release state. Preferably the catch includes an independent power supply. In an example the independent power supply includes at least one of a battery, a trickle charged rechargeable battery or a capacitor.

In an example a latch member is arranged intermediate first and second equilibrium positions. Preferably the arrangement includes at least one of a pivot, a hinge, a spring and a slider.

According to another aspect of the present invention there is provided a kit for modifying a door closer having a housing cover and a door closure mechanism to provide the door closer with door retention functionality for retaining a door in an open position, the kit comprising: a replacement housing cover adapted for replacement of the housing cover of the door closer; and a door retention mechanism adapted for assembly with the replacement housing cover and the door closer to form a modified door closer in which the door retention mechanism cooperates with the door closure mechanism to provide said door retention functionality for retaining a door in an open position.

According to another aspect of the present invention there is provided a method of modifying a door closer having a housing cover and a door closure mechanism to provide the door closer with door retention functionality for retaining a door in an open position, the method comprising: removing the housing cover of the door closer; replacing the removed housing cover of the door closer with a replacement housing cover to which a door retention mechanism is fitted, which door retention mechanism is adapted to cooperate with the door closure mechanism to provide said door retention functionality.

The door retention mechanism may comprise a catch device according to the first aspect (or otherwise as herein described).

The replacement housing cover and the door retention mechanism may be provided in the kit in an assembled form (e.g. integrated with or otherwise fitted to one another) or an un-assembled form.

According to a yet further aspect of the present invention, there is provided a valve apparatus for controlling fluid flow, the valve apparatus comprising: first and second magnetic elements spaced apart from each other; a movable element such as a keeper element preferably arranged relative to the magnetic elements, the movable element being movable between first and second holding positions wherein in the first holding position the movable element is held by a magnetic force of the first magnetic element and in the second holding position the movable element is held by a magnetic force of the second magnetic element; means for releasing the movable element from one of the holding positions, the released movable element moving to the other holding position; and means for controlling said flow of fluid in dependence on the position of the movable element.

Preferably, the controlling means is adapted to control fluid flow such that when the movable element is in one of said first and second holding positions the valve apparatus substantially stops said fluid flow and when the movable element is in the other of said first and second holding positions the valve apparatus allows said fluid flow.

Preferably, the controlling means comprises a shaft with a through hole, and a through hole in the movable element, the movable element being slidably disposed within the shaft and wherein the through holes do not align in one of said first and second holding positions to substantially stops said fluid flow, and the through holes align in the other of said first and second holding positions to allow said fluid flow.

Preferably, the movable element is arranged between the magnetic elements.

Preferably, the magnetic element includes a permanent magnet. More preferably, the permanent magnet is arranged to hold said movable element in said first or second holding position and wherein the movable element release means is operable to release said movable element from said first or second holding position by overwhelming said permanent magnet.

Preferably, the magnetic element includes an electromagnet.

Preferably, said movable element is released from said first or second holding position when said electromagnet is energised.

Preferably, the valve apparatus includes means for applying a signal to an actuator to effect the release of the movable element.

Preferably, the valve apparatus includes means for applying a current to the magnet element to effect the release of the movable element.

Preferably, the current is applied for a period of time sufficient to release said movable element and wherein after said movable element is released said current is stopped.

Preferably, the movable element is retained in said first or second holding position without requiring the application of an electric current.

Preferably, the apparatus is adapted for interaction with an element of an apparatus for controlling the movement of a closure.

Preferably, the movement of the movable element is adapted to change the state of the device from a closure retaining state to a closure release state.

Preferably, the valve apparatus is configured for controlling the flow of oil (or possibly water) for a hydraulic system or air for pneumatic system.

Examples also provide a door closer substantially as herein described with reference to the accompanying drawings and a bistable latch substantially as herein described with reference to the accompanying drawings

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Preferred features of the present invention will now be described, purely by way of example, with reference to the accompanying drawings, in which:

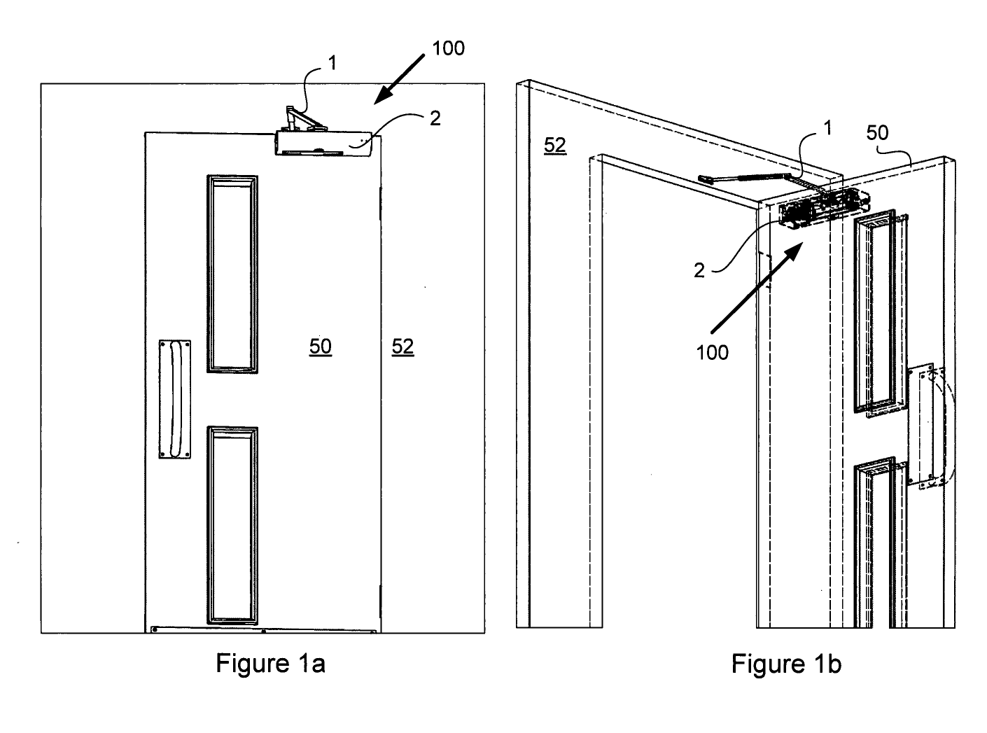

FIGS. 1a and 1b show in perspective views the general operation of examples of a door retainer/closer;

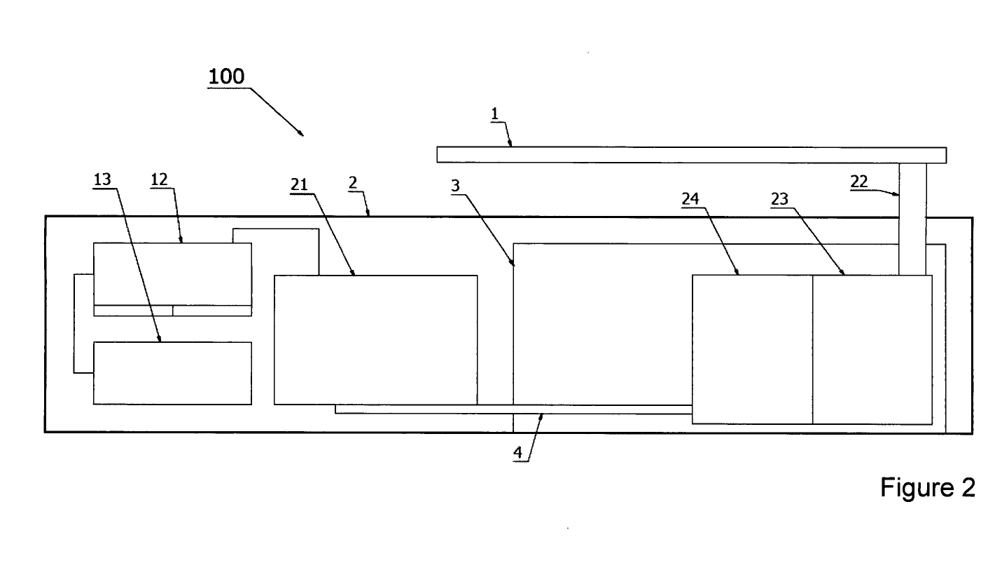

FIG. 2 shows schematically the components of an example door retainer/closer;

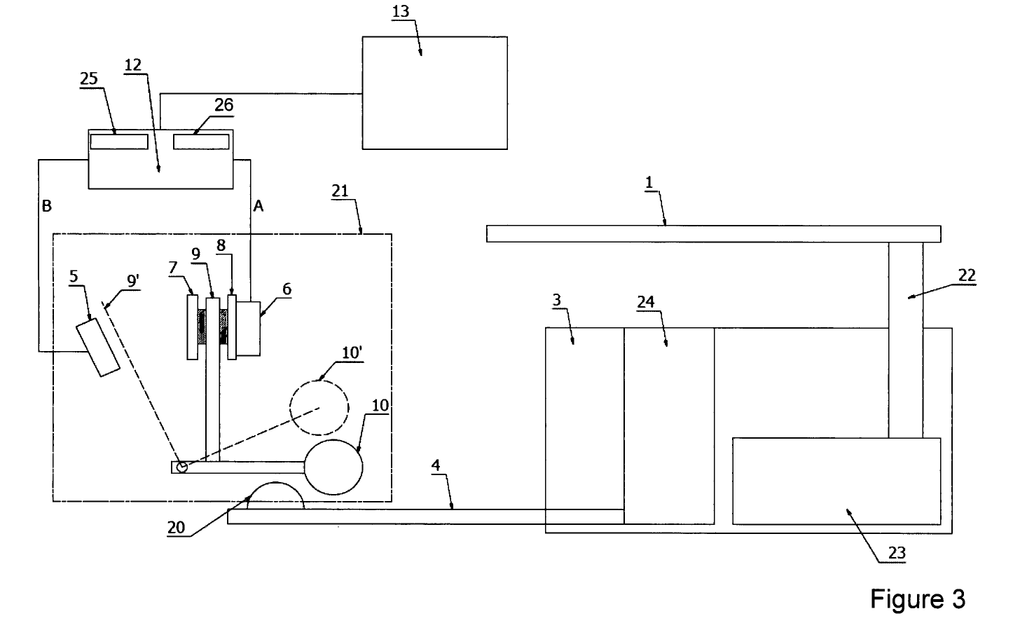

FIG. 3 shows further features of the door retainer/closer of FIG. 2.

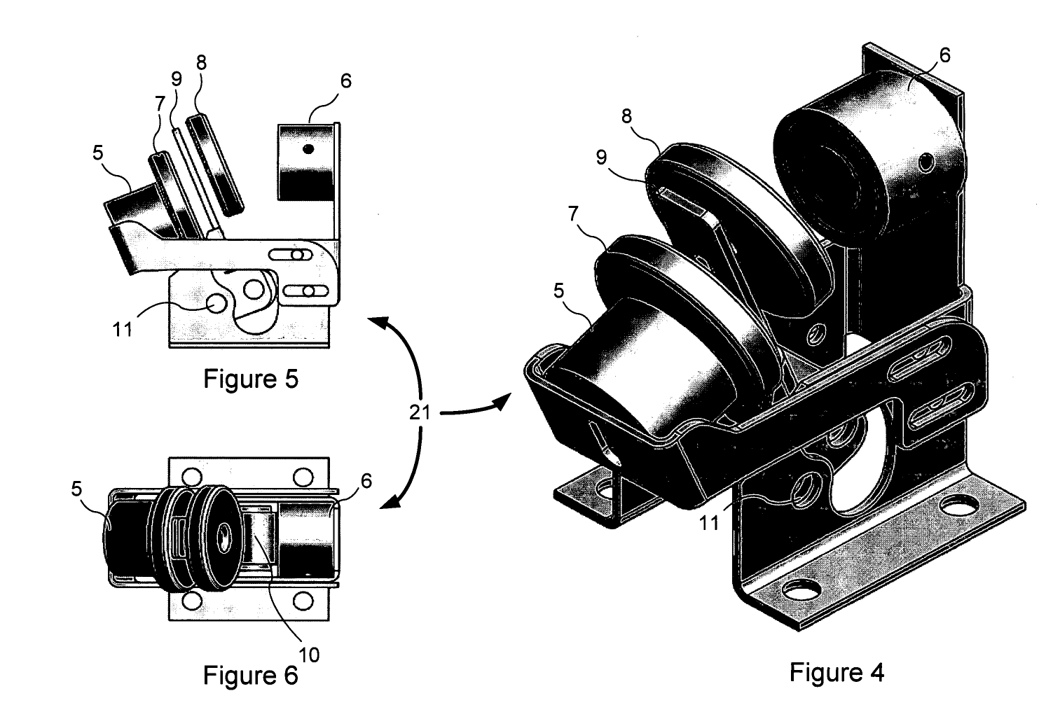

FIG. 4 shows a perspective view of a bistable latch;

FIG. 5 shows a side view of the bistable latch of FIG. 4;

FIG. 6 shows a plan view of the bistable latch of FIG. 4;

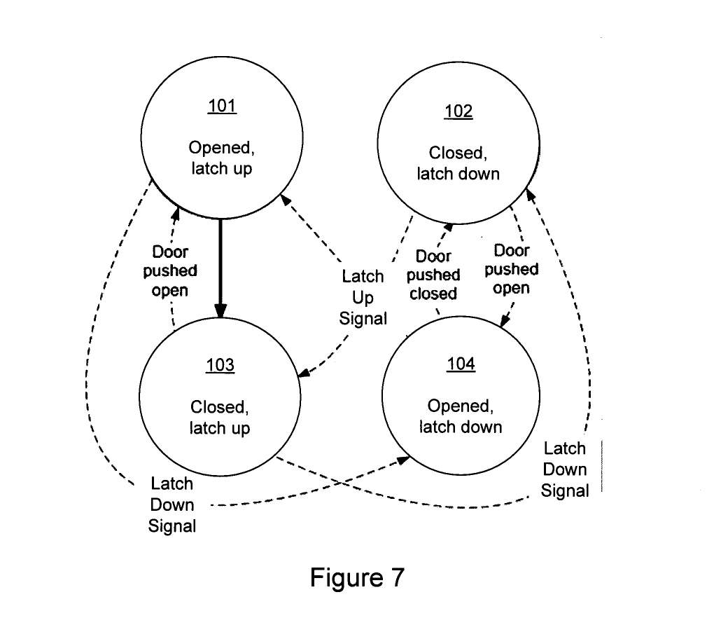

FIG. 7 shows a state diagram illustrating operation of a door retainer/closer;

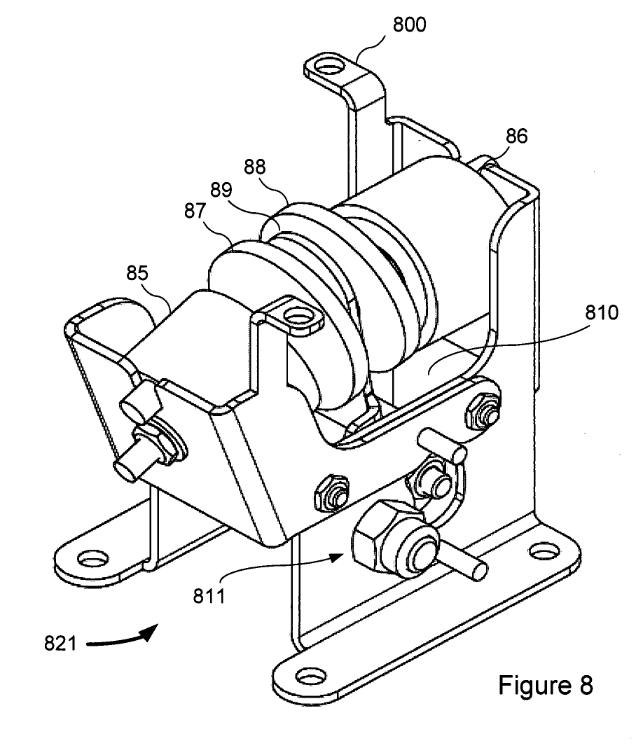

FIG. 8 shows a perspective view of another bistable latch;

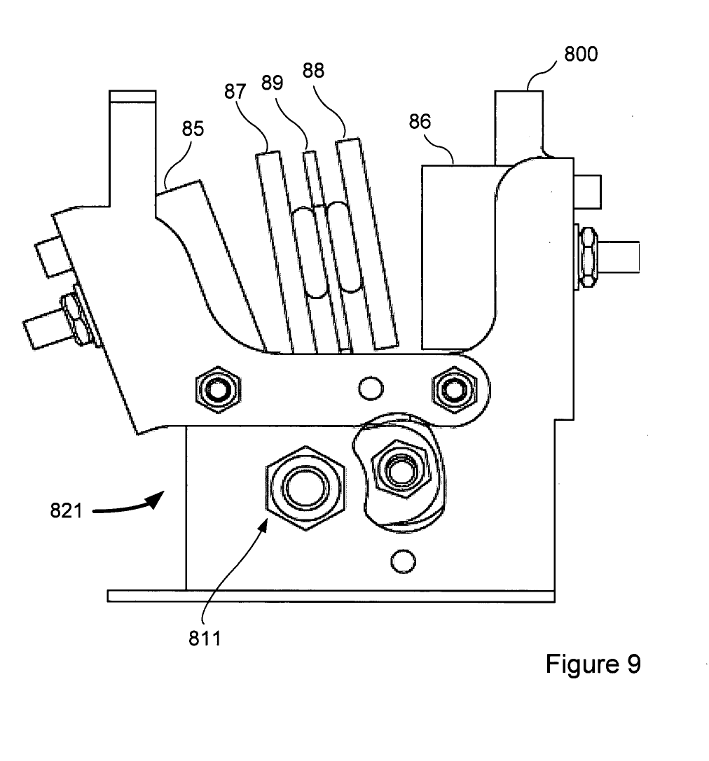

FIG. 9 shows a side view of the bistable latch of FIG. 8;

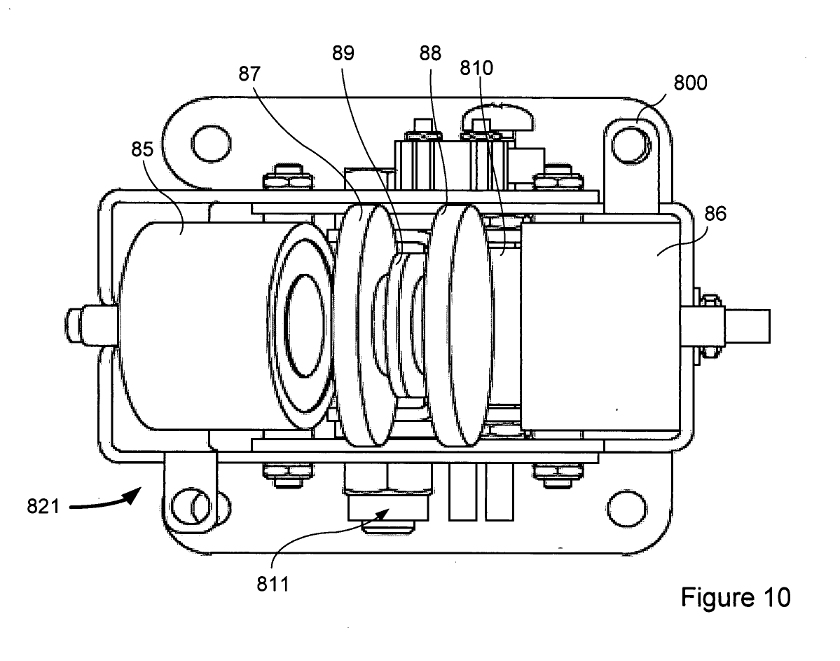

FIG. 10 shows a plan view of the bistable latch of FIG. 8;

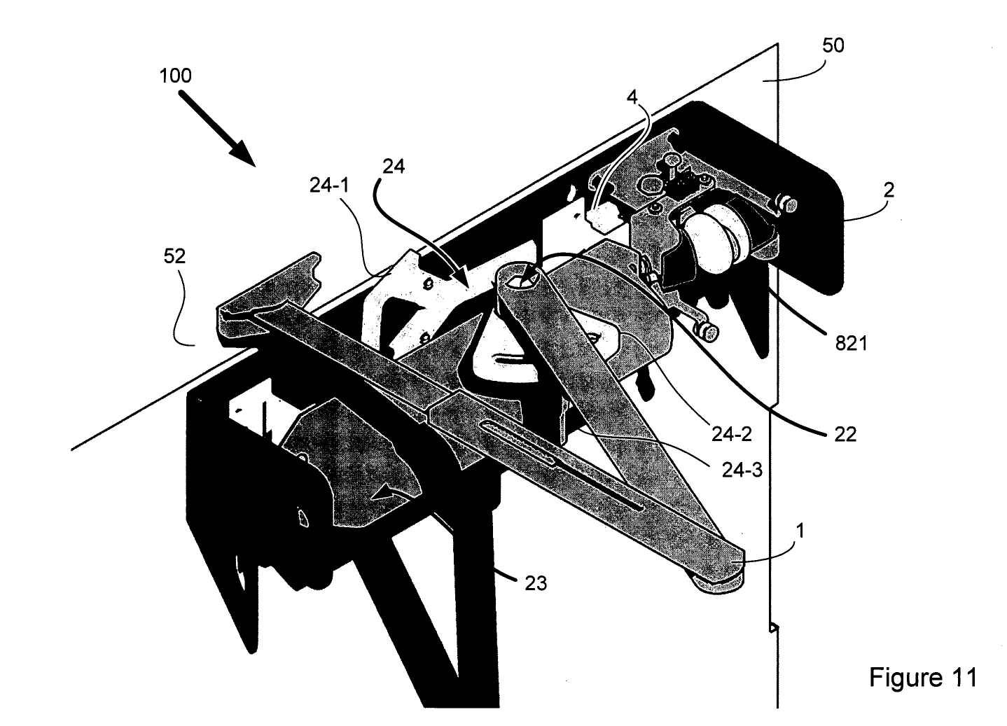

FIG. 11 shows a view of a closed door featuring a closer device in which the bistable latch of FIG. 8 has been employed;

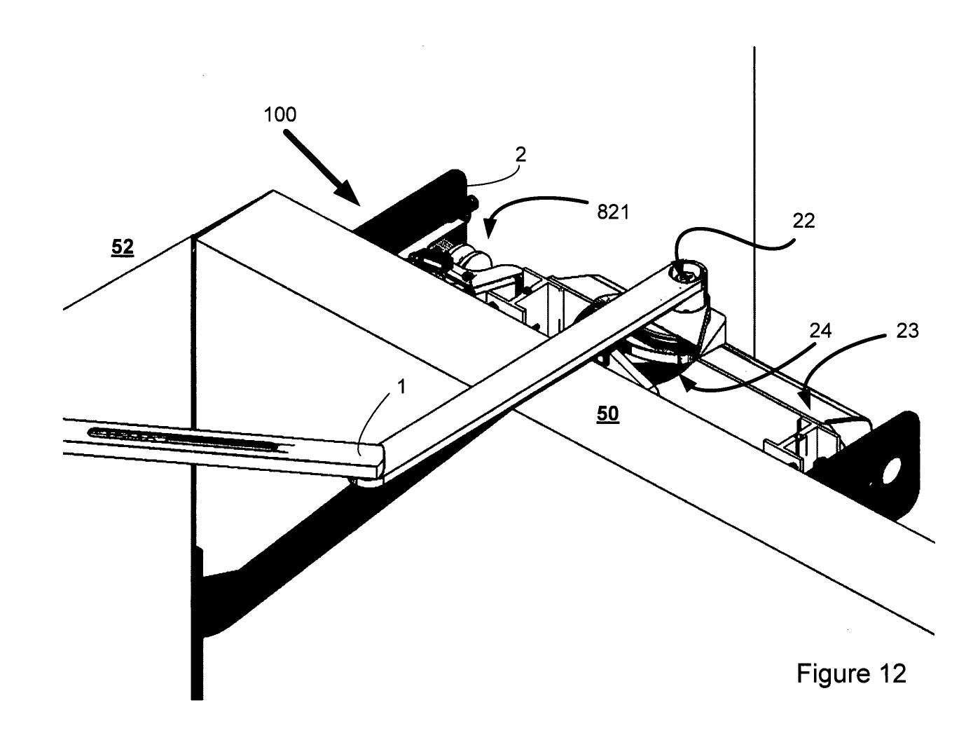

FIG. 12 shows a view of an open door featuring the door closer device of FIG. 11;

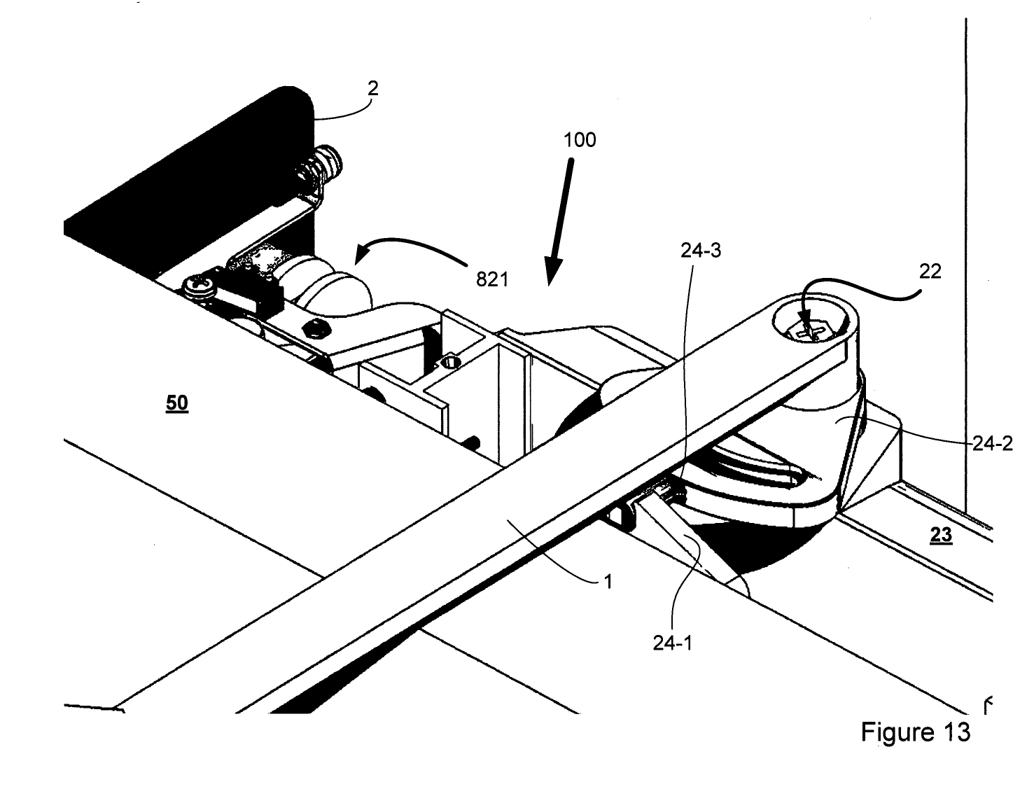

FIG. 13 shows a close up of a portion of FIG. 12;

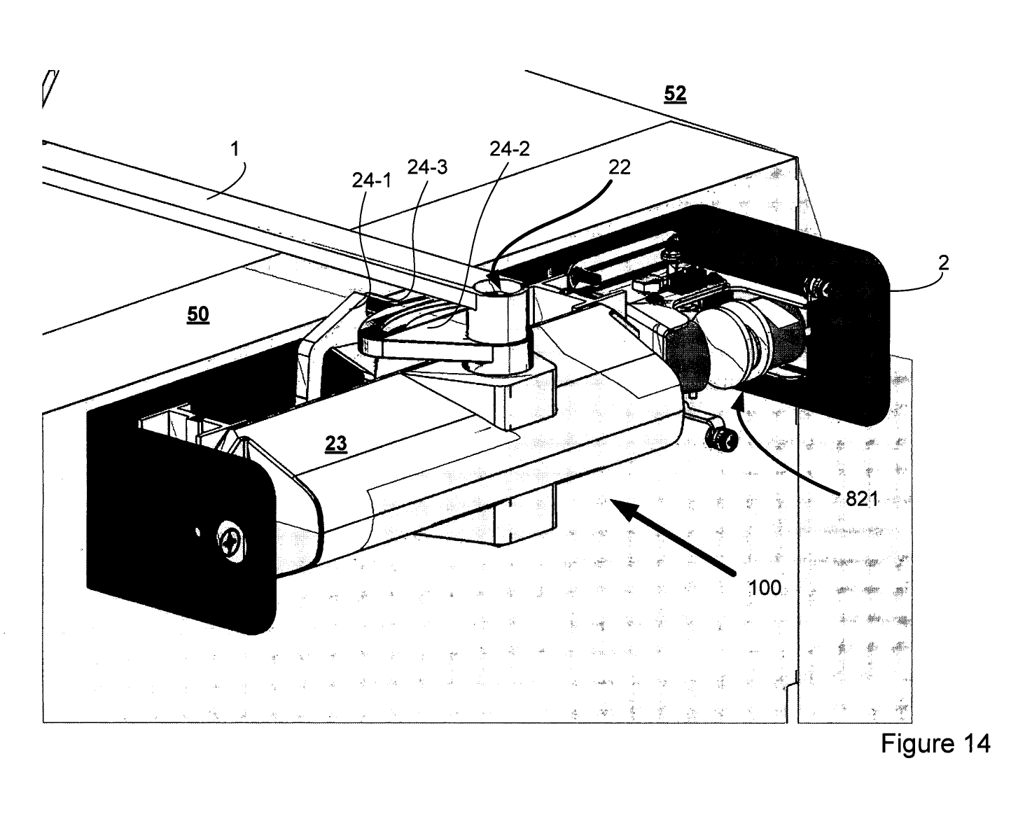

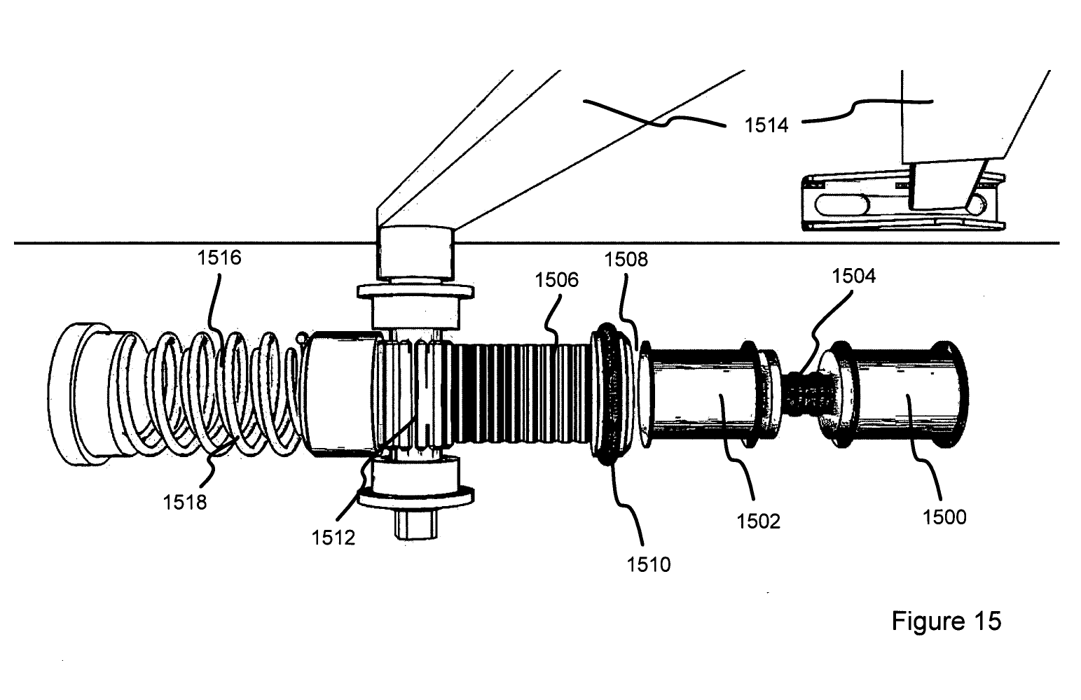

FIG. 14 shows another view of an open door featuring the door closer device of FIG. 11;

FIG. 15 shows, in simplified form, a mechanism for a door closer in which an alternative bistable arrangement has been employed;

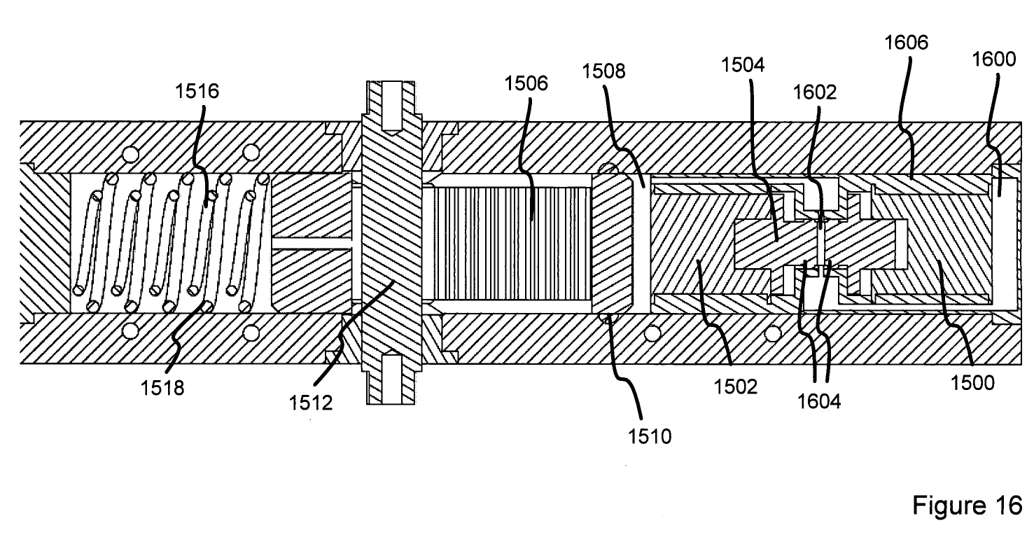

FIG. 16 shows a cut-away view of the mechanism for a door closer of FIG. 15 in an open position;

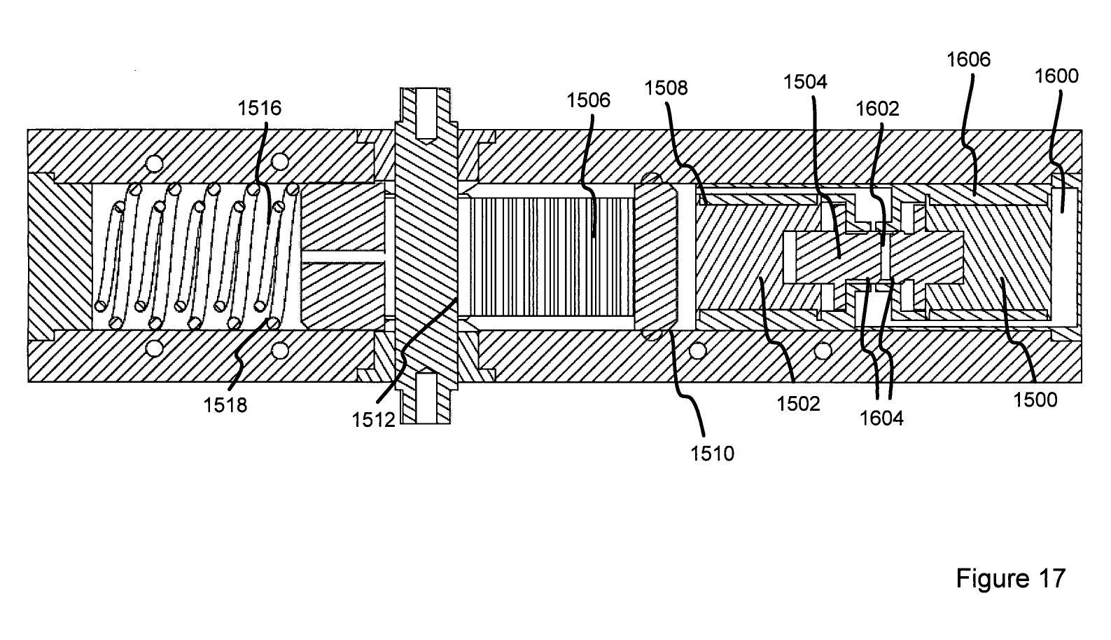

FIG. 17 shows a cut-away view of the mechanism for a door closer of FIG. 15 in a closed position;

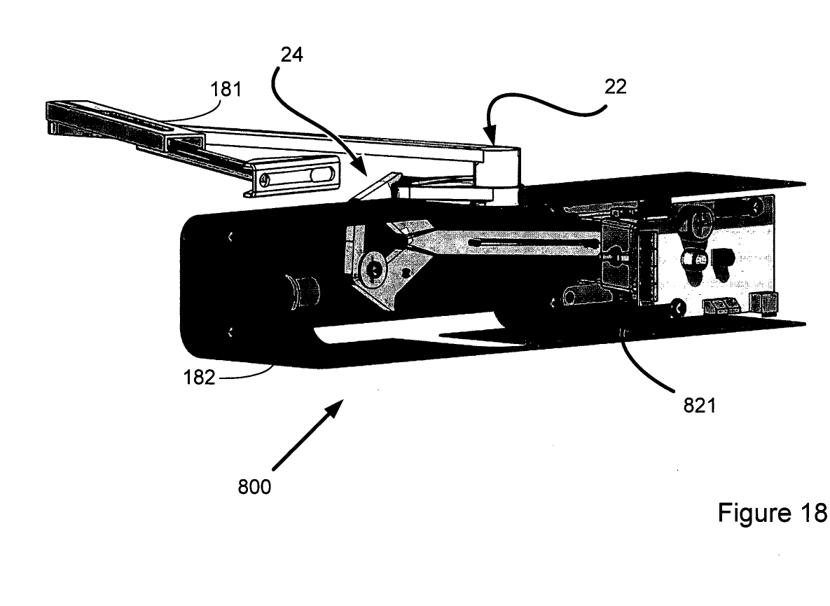

FIG. 18 shows an arrangement suitable for retrofitting a door closer device with a retainer mechanism comprising a bistable latch; and

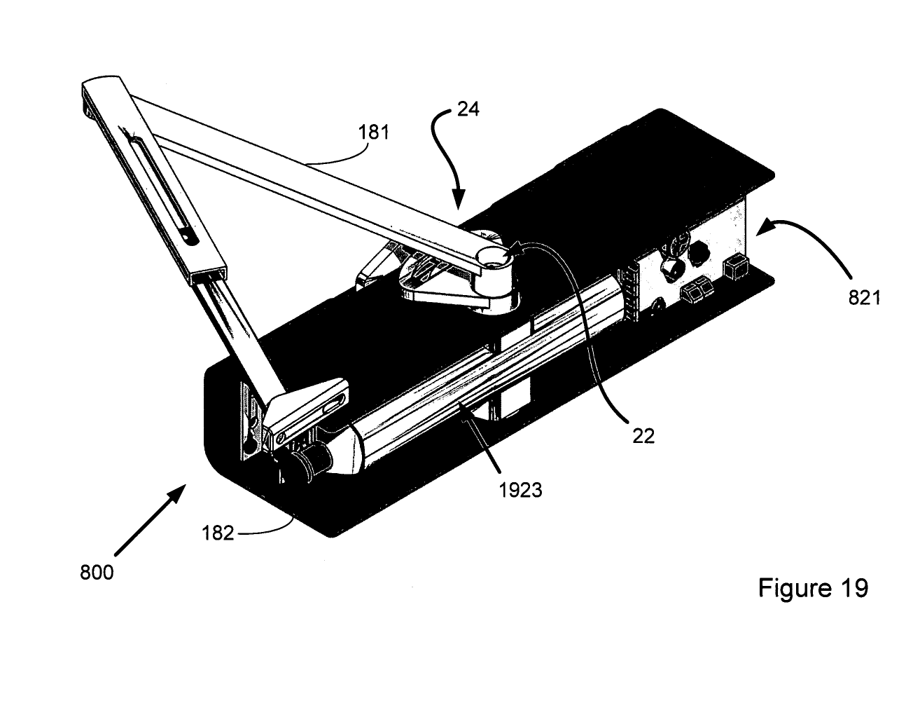

FIG. 19 shows an alternative view of the arrangement of FIG. 17.

FIGS. 1a and 1b show door arrangements each including a door 50 mounted in a door frame 52 in a conventional way. A door retainer/closer 100 is mounted to an upper part of the door arrangement. The door retainer/closer 100 includes a housing 2 mounted on the door and housing the retaining/closing mechanism 3, and a jointed arm 1 which connects the retaining/closing mechanism to the door frame 52. The arm 1 is coupled to a biasing device in the retaining/closing mechanism which acts to bias the door so that when the door is in an open position (FIG. 1b), the mechanism acts to move the door to a closed position (FIG. 1a).

FIG. 2 shows schematically the elements of a door retainer/closer 100 of examples of the invention. The door retainer/closer 100 includes a housing 2 for mounting on a door 50 and a closing arm 1 extending from the housing for connecting the retainer/closer 100 to the door frame 52. The housing 2 contains a retaining/closing mechanism 3 which is connected to the arm 1.

As for conventional devices, the retainer/closer can be mounted onto the door in any appropriate arrangement. It can be mounted either to the inner or outer surface of the door. In some arrangements, the housing can be mounted to the door frame 52 or adjacent surface, the arm 1 being connected to the door 50.

The retaining/closing mechanism or linkage mechanism 3 includes a biasing element 23 and restraint mechanism 24. The biasing means 23 is connected to the arm 1 via a rotatable spindle 22. As the door is moved between an open and closed positions, the arrangement of the arm 1 causes the arm to move and the spindle 22 to rotate. The biasing device 23 is arranged to apply a torque to the spindle to urge the arm 1 towards a position in which the door is closed. In this way, when the door is released, the door moves to the closed position. Various ways of achieving the biasing force are known in the field; for example, the biasing device 23 may include a spring mechanism.

The restraint mechanism 24 is operable to selectively hinder or prevent the closing of the door under the action of the biasing device 23. For example, operation of the restraint mechanism 24 can prevent the arm from moving towards the closed position. For example, the restraint mechanism may include a projecting element movable towards and away from a position in which it is arranged to hinder or prevent the movement of the arm. For example, the restraint mechanism may provide a stop to hold the door at a particular position. Thus the restraint mechanism can be used to prevent the door being closed under the action of the biasing device 23. An example of a door closer including a restraint mechanism is described in GB2183290A (see for example FIGS. 1 to 3). Alternatively or in addition, the restraint mechanism may act on the biasing means to prevent it from acting on the arm, and/or on the spindle, for example to prevent it turning past a predetermined position.

In the arrangement shown in FIG. 2, the linkage mechanism 3 further comprises control rod 4 which extends from the linkage mechanism 3 to a bistable catch 21. The control rod is arranged for controlling the activation of the restraint mechanism 24 as described in further detail below.

As shown in the arrangement of FIG. 2, a bistable catch 21 is mounted adjacent the extending end of the control rod 4.

Features of the bistable catch 21 are shown in more detail in FIGS. 3 to 6.

Firstly, having reference to FIG. 4, the bistable catch 21 includes first and second magnet elements 5, 6 which are arranged spaced apart from each other mounted on a frame adapted to be fixed to the housing 2. One example of a frame arrangement is shown, although it will be understood that other arrangements are possible.

Between the magnet elements 5, 6 is arranged a latch member 9 pivotally mounted to the frame of the catch 21 at a pivot 11. Mounted on the latch member 9 between the magnet elements 5, 6 are two keeper elements, here keeper plates 7, 8. The keeper plates may comprise any suitable material such that the keeper plates 7, 8 may be attracted to and retained by the magnetic force of the magnets 5, 6. For example, the keeper plates may comprise steel, although other material may be used. FIGS. 4 to 6 show the attachment of the keeper plates to the latch member 9 in slightly exploded view for clarity.

The latch member 9 is mounted at the pivot 11 such that the latch member 9 is movable between a release position (shown in FIG. 4) in which keeper plate 7 is held against the magnet 5, and a catch position (shown in FIG. 3) in which keeper plate 8 is held against the magnet 6. A light spring (or springs) may be used to assist the movement of the latch member 9 between the two magnets 5 and 6.

Each magnet element 5, 6 includes a permanent magnet, and a coil arranged around the magnet and connected to a controller 12 as described in more detail below in relation to FIG. 3.

In normal operation, the permanent magnet of the magnet elements 5, 6 acts to attract an adjacent keeper plate 7, 8, thereby holding the latch member 9 either in the catch position or in the release position. To switch the latch member 9 between the two positions, current is applied to the coil of one of the magnet elements 5, 6 thereby generating a field in the element which counteracts the field generated by the permanent magnet, thus creating a net effect of temporarily demagnetising the magnet element and thus releasing attached keeper plate. When one keeper plate is released, the other keeper plate is attracted to the permanent magnet of the other magnet element, thus moving the latch member 9 between the catch and release positions. A spring or other biasing assembly may additionally be provided to bias the latch member against one or other of the magnet elements.

As shown in FIG. 3, latch member 9 also includes an engaging roller 10. With reference to FIG. 3, as the latch member moves between the catch and release positions (9 and 9′), the engaging roller 10 moves towards and away from the control rod 4.

As seen in FIG. 3 (in which the components are not shown to scale for clarity), the control rod 4 bears a protrusion 20 in the region of the latch member 9.

With the latch member 9 positioned in the catch position shown in FIG. 3, the engaging roller 10 is positioned for engagement with the protrusion 20 of the control rod, thus restricting the movement of the control rod. By restricting the movement of the control rod, the restraining mechanism 24 acts to retain the door.

When the latch member 9 moves to the release position (shown in dotted outline in FIG. 3), the engaging roller moves away from the position of the protrusion 20, leaving the control rod free to move so that the door can be released and can move closed under the action of the bias means 23.

Any appropriate control rod 4 and restraining member 24 arrangement may be used to effect the retaining and release of the door. An example of a suitable arrangement is the button, shank portion and end part arrangement of GB2207187 and shown in FIG. 2 of that document.

The use of the bistable catch to control the movement of a door is now further described having reference to the state diagram in FIG. 7 to illustrate states of the door and latch mechanism. The door may be in an opened latch up state 101 (door open and latch member in the release position), an opened latch down state 104 (door open and latch member in the catch position), a closed latch up state 103 (door closed and latch member in the release position), and an closed latch down state 102 (door closed and latch member in the catch position). Transitions between these states are illustrated using arrows labelled with the condition required to move between states.

When the door is in an opened latch up state 101 it will close automatically under the action of the biasing means 23 of the door closer. With the latch up (the latch member 9 in the release position), the door will not be retained at any angle, and will always tend to the closed position.

When the door is in a closed latch up state 103 it may be pushed open by a user but it will then close under the action of the door closer.

After the relevant magnet element (element 5 in this example) has been actuated so that the latch member 9 moves to the catch position, the door is held open once it has been pushed open.

When the door closer is in a latch down state 102, 104, the door may be pushed open or closed and will remain in position until moved manually or the latch member 9 is moved to the release position.

In some arrangements, the door might only be held in the retained position once the door had been pushed open more than a particular angle. Once pushed past the retaining position, the door will not close beyond the retaining position until either it is pulled close past the retaining position (at which position it may close under the force of the bias means 23, or might stay in any position to which it is moved, depending on the particular action of the door retaining/closing mechanism), or the latch member 9 has been moved back to the release position.

FIGS. 8 to 10 show a variation on the bistable latch 21 of FIGS. 4 to 6 generally at 821.

The bistable latch 821 comprises substantially the same key features and operates in substantially the same manner as the bistable latch 21 of FIGS. 4 to 6 and like parts are give like reference numerals prefixed with the numeral ‘8’. The bistable latch 821 may, for example, be employed in a door retainer/closer 100, as described with reference to FIGS. 2 and 3, in a similar manner to the bistable latch 21 of FIGS. 4 to 6.

The bistable latch 821 comprises an additional mounting point 800 for securing the bistable latch 821 in its correct position in the housing 2 of the door retainer/closer 100. For illustrative purposes, unlike the illustrations of FIGS. 4 to 6, FIGS. 8 to 10 also show the bistable latch 821 in an assembled form in which the various parts of the latch 821 are secured to one another with nuts and bolts.

FIGS. 11 to 14 show the internal workings of a typical door closer/retainer 100, in operation, in the doorway 50, 52. In FIGS. 11 to 14 the bistable latch 821 of FIGS. 8 to 10 has been employed although it will be appreciated that the following description applies equally to the bistable latch 21 of FIGS. 4 to 6.

As seen in FIGS. 11 to 14, the restraint mechanism 24 comprises a claw arm 24-1 at the end of the control rod 4, a radial arm 24-2 on the spindle 22 between the lever arm 1 and the biasing device 23, and a radial projection 24-3 extending from the radial arm 24-2.

The radial arm 24-2 rotates with the spindle 22 as the door opens and closes and the lever arm 1 moves accordingly.

When the latch member 89 of the bistable latch 821 is in its latch down state 102 and the door is opened, the radial arm 24-2 rotates from a position in which the projection 24-3 is disengaged from the claw arm 24-1 into a position in which the projection 24-3 engages with the claw arm 24-1. With the bistable latch 821 in its latch down state 102, when the door 50 is then released, the claw arm 24-1 is restrained from movement out of engagement with the projection 24-3 and the radial arm 24-2 (and hence the spindle 22) is inhibited from rotating. Thus, the door 50 is retained in the open position until it is manually closed or the latch member 89 is released.

When the latch member 89 of the bistable latch 821 is in its latch up state 103, and the door is opened from its closed state, the projection 24-3 moves into engagement with the claw arm 24-1 but is not retained when the door is released. Instead, when the door 50 is released and begins to close under the influence of the biasing device 23, the claw arm 24-1 is forced out of engagement with the projection 24-3 as the radial arm 24-2 rotates with the spindle 22. Thus, in this scenario, the door 50 will not be held in place but will close under the influence of the biasing device 23.

In an alternative embodiment, a bistable latch is provided in the form of a valve arrangement as shown in FIGS. 15, 16 and 17. The valve arrangement may be used within a hydraulic, pneumatic or other such door retainer/closer as described herein. In overview, the latch operates by closing a hydraulic (or pneumatic) valve using a first permanent magnet, enabling the door retainer/closer to retain the door in an open position, as the hydraulic fluid may not flow through the valve thus preventing a piston, attached to the door, from moving. In an alternative position, a second permanent magnet is provided to hold the valve open, and thus allow the door to close without being retained by the latch, as the hydraulic fluid may now flow through the valve, allowing the door to close freely.

An example of this embodiment is shown in broad overview in FIG. 15 (for clarity the outer casing of the mechanism is not shown). There are shown two magnet elements 1500 and 1502, similar to those described above, and as such they each comprise a permanent magnet and an electromagnetic coil (the electromagnetic coil, when energized, being used to counteract the field generated by the permanent magnet, thus creating a net effect of temporarily demagnetising the magnet element). The ferromagnetic piston/keeper 1504 is slidably positioned within a cylinder (not shown in this view) between the magnet elements. The keeper/valve 1504 is adapted to act as a valve to control the flow of fluid (for example hydraulic fluid, or air) from a first reservoir (not shown) to a volume 1508 (wherein the volume is substantially defined by the end face of a geared slide, 1506, and the end face of magnet element 1502). The o-ring seal 1510 acts to prevent fluid from escaping from the volume.

The geared slide 1506 is connected to a geared pivot shaft 1512, which in turn is connected to a door closer arm 1514. The door closer arm is attached to a door frame, and the mechanism is attached to a door. The geared slide and geared pivot shaft are arranged such that when a door is opened/closed the rotational motion of the geared pivot arm is translated into linear motion of the geared slide. Thus, when the door is opened/closed the geared slide acts to force fluid to/from the volume from/to the reservoir via the keeper/valve 1504. Therefore, the position of the keeper/valve 1504 can control the flow of fluid, and, for example, hold the door open. When the keeper/valve 1504 is in the open position the springs, 1516 and 1518, act to close the door without the requirement of any external force. In this way, the mechanism can be used on a fire door or the like.

FIG. 16 shows a cross-sectional view of the bistable latch shown in FIG. 15, where like numerals indicate like features. As can be seen the volume 1508 is in fluid communication with the reservoir 1600 via a through hole 1602 in the keeper/valve 1504. Seals 1604 are provided either side of the through hole 1602 to prevent fluid leakage past the keeper, and thus the magnet elements are separated from the fluid. The housing 1606 is non-ferrous. When the bistable latch is in the open position as shown in FIG. 16 the magnet element 1502 holds the keeper/valve in this open position until the permanent magnet is counteracted by energising, with a pulse, the electromagnetic coil. When the permanent magnet is counteracted in this way, the keeper/valve moves to the closed position shown in FIG. 17.

FIG. 17 shows the same view of the mechanism as that in FIG. 16, but the keeper/valve 1504 is in the closed position. As can be seen, the through hole 1604 no longer allows fluid communication between the volume 1508 and the reservoir 1600. Therefore, the geared slide is held in position, and thus the door is held in position (open, or alternatively closed).

Alternative arrangements of the keeper/valve are also possible. For example, the end faces of the keeper/valve may be flat, and thus the magnet elements may have flat faces.

In an alternative embodiment, two grooves may be cut into the keeper/valve, with seals fitted in place. The seals may be larger than the valve hole in the casing so that in transit they will not become stuck and would further prevent seepage of fluid.

Alternatively, the above described hydraulic (pneumatic) arrangements are provided with at least one spring acting on the piston/keeper plate to bias the keeper/valve 1504 to a neutral position between the magnets. In each case the piston/keeper plate may be provided with a sealing ring.

Thus in examples described herein, it is advantageously not necessary to apply a current to the device to retain the door in the open position. It is only necessary to apply a current to cause the bistable catch to move between a retaining state and a release state. It is also advantageous in some examples that once the device has been tripped so that the catch is in the release state, it is necessary actively to provide a reset (to move the catch to the retaining state) for it to be possible for the door to be held open.

Further advantageously it is necessary to provide a particular reset signal (a latch down signal) to return the door closer to a state in which it may be retained open.

The actuation of the magnet element to move the catch between the retaining and release states may be triggered by any appropriate means. For example, the actuation may be triggered manually or under the control of a control system. For example, controller 12 may be coupled to one or both of the magnet elements 5, 6, 85, 86 for effecting actuation of one or other of the elements at the appropriate time.

For the operation of the bistable catch 21, 821, the magnet elements 5, 6, 85, 86 are coupled to a controller 12 which controls the supply of electricity to the magnet elements to effect actuation and thus release of the keeper elements 7, 8, 87, 88.

A separate controller could be used to control the operation of each of the magnet elements 5, 6, 85, 86 but conveniently, both elements are controlled from a single device.

The power for actuating the magnetic element may be provided from the mains (so that the device is wired-in to the mains supply) or from another local power supply, for example one or more battery devices 13 as shown in FIGS. 2 and 3.

A battery device may be provided even where mains power is supplied, for example to give a back-up power supply.

In preferred examples, the actuation of the device to move the catch into the release state may be triggered by an alarm condition, for example a fire alarm.

As shown in FIG. 3, the device may include one or more receivers or sensors 26 for receiving information regarding an alarm condition.

For example the device may be wired into a fire alarm and the controller may include a receiver 26 for receiving a signal from the fire alarm system. The receipt of the signal can be used to trigger the actuation of the catch.

In some examples, the device includes an acoustic sensor 26, and preferably the actuation can be triggered in response to a sound of a predetermined character. Thus, in the case of a fire alarm system, for example, by actuating the catch device in response to sound of a predetermined character (typically the sound of a fire alarm), a hard-wired link with the fire alarm system can be avoided. Hence the apparatus can be relatively easily fitted to react to an existing fire alarm system installed already in the building.

The controller 12 may be adapted to determine whether or not the sound is indicative of an alarm condition, for example in one or more predetermined frequency ranges, of a predetermined continuous duration and/or above a predetermined intensity threshold. A tone discrimination circuit may be used.

As an alternative, or in addition, the alarm signal may include a signal transmitted into the ambient medium, for example from a control centre. For example, the alarm signal may comprise a radio frequency signal transmitted by the fire alarm control panel. The signal may be transmitted by a radio transmitter adapted to identify an alarm condition and transmit an alarm signal. An example of such a device is the DORGARD X control device of Fireco Limited. The control device could be used to trigger one or more closure devices.

Further examples of the actuation of apparatus in response to an alarm condition are given in International Patent Application No. WO93/20317, the contents of which are incorporated by reference.

In some examples, a manual reset is required, for example a manual input will be required to move the catch back to the retaining state.

In preferred examples, the device includes a fail to safe device.

The device may be adapted such that the catch moves to the release position if a release condition arises where release of the door is desirable for safety or other reasons. Examples of a release condition may include, for example, a loss of power, the power dropping below a predetermined threshold, tampering with the device, an error detection, battery removal, force over a particular threshold applied to the door, or a time of day, temperature or other environmental factor being determined.

Depending on the required functions of the controller, the controller 12 may further comprise additional sensors 26 or other components which may include for example a receiver (for example a radio receiver), a microphone, a temperature sensor, a PIR detector, a control signal receiver, a power supply detector, timer device.

It will be understood that the present invention has been described above purely by way of example, and modification of detail can be made within the scope of the invention.

For example, where in the example shown in the drawings the protrusion 20 is depicted as a raised button or nub, as will be appreciated any suitable engagement means may be used. Similarly the structural features of roller 10, 810 are dependent only on the corresponding features of the protrusion 20, therefore it will be apparent to the skilled practitioner in the context of the present application that other suitable configurations may be employed to engage the bistable latch with a door closer control means.

Where the latch member 9, 89 is shown as being mounted to a pivot 11, 811 it will be appreciated that this pivot mounting may be replaced with any appropriate mounting which permits the latch member to move between equilibrium states so as to control engagement with and control of a door closer. The latch member 9, 89 may for example be biased by a spring arrangement or any other resilient or biasing means.

Different arrangements may be provided to replace the latch/keeper plates of the example described. Any arrangement suitable for moving between the two equilibrium positions under action of the magnet elements would be appropriate.

Different ways of actuating the magnet element to release the latch are also possible.

Controller 12 may comprise any suitable digital circuitry such an ASIC, a FPGA, individual logic gates or other control circuitry. These examples are provided by way of illustration only and in no way limit the scope of the invention.

In preferred examples any sensors are coupled to an internal power supply 13 and the device includes a power supply detector 25 which is coupled to determine whether an external power supply is available to the controller and, in the event that it is not to cause the controller to provide a signal to actuate the latch to move it to a release, fail safe, state. Advantageously this fail to safe function ensures that the door is not held in a latch down, hold-open state in the event of a power cut.

A fail-to-safe power supply 13 may be provided by a battery or a capacitor or any other power storage or supply means. Preferably where a battery or capacitor is used it is arranged to be charged during normal operation of the door so that in the event of a loss of external power the controller can provide a signal to effect the release state. Further preferably the controller 13 includes a fail-to-safe power level detector which detects the remaining level of fail-to-safe power and, in the event that the remaining power falls below a predetermined level the controller is configured to effect a release state and not to allow a retaining state until sufficient fail-to-safe power has been stored.

A safety condition may for example include a power failure, a fire, a fire alarm or a security signal. Safety conditions may be detected by electronic or magnetic means or by means of a signal transmitted through the ambient medium, for example a fire alarm sound or a transmitted RF or infrared signal. Preferably if a fire alarm signal is to be detected the safety sensor may include suitable detection means, for example including a tone discrimination circuit.

The latch may be provided with a manual override so that movement between the retaining and release states can be achieved without the provision of a control signal.

In an example a bistable latch includes a solenoid with a permanent magnet disposed at one end, a latch engagement element disposed adjacent its opposite end and a biased latch member extending at least partially into the solenoid. In this example a first equilibrium state is provided by magnetic engagement between the latch member and the permanent magnet and a second equilibrium state is provided when the biased latch member is biased against the latch engagement. Transition between equilibrium states of a bistable latch according to this example may be effected by applying solenoid signals of opposing polarity to move the latch member between equilibrium states. The latch member may be biased for example by the influence of a second permanent magnet.

The catch has been described herein for use with a door retainer/closer device. The catch may also be used in other apparatus, for example a door retainer. In some arrangements a separate door closer may also be present

FIGS. 18 and 19 show another advantageous implementation of the bi-stable latch in a door closer device. The implementation of FIGS. 18 and 19 is particularly beneficial for fitting in installations having existing compatible door closer devices because it allows the existing door closer devices to be upgraded with relative ease and at relatively low expense.

The implementation shown in FIGS. 18 and 19 comprises a retrofit arrangement 1800 comprising the bistable latch 821, the features of the restraint mechanism 24, and a housing cover 182 which is compatible with a housing of an existing door closer device (e.g. the size, shape and fixing features of the housing cover 182 allow it to be used as a replacement for the cover of the existing door closer device). In FIGS. 18 and 19 the retrofit arrangement 1800 is shown in a partially assembled form in which the bistable latch 821 and the features of the restraint mechanism 24 are fitted to the housing cover 182. The bistable latch 821 and the features of the restraint mechanism 24 are arranged for cooperation with the biasing mechanism 1923 and lever arm 181 of the existing door closer device such that when the retrofit arrangement 1800 replaces the housing cover of the existing closer device, the restraint mechanism 24 acts to retain or release the door 50 substantially as described previously.

It will be appreciated that the lever arm 181, the biasing mechanism 1923, and any other parts of a door closer device may also be provided as part of the retrofit arrangement 1800. The retrofit arrangement 1800 may also be provided as a kit of parts possibly including parts having different configurations suitable for retrofitting to different pre-existing door closer devices. The inclusion of such parts beneficially has the potential to allow an installer a choice of the extent to which an existing door closer device should be replaced (for example, to replace faulty or incompatible parts) and a choice of the best parts to use for a particular specification of existing door closer device.

It will also be appreciated that the magnet element and keeper arrangement may be varied. For example, the permanent magnets may be arranged on the keeper, with the electromagnets arranged at the first and second positions of the keeper. Or, for example the electromagnets may be arranged on the keeper, with the permanent magnets arranged at the first and second positions of the keeper, or any suitable combination thereof.

Each feature disclosed in the description, and (where appropriate) the claims and drawings may be provided independently or in any appropriate combination.

1. A catch device for use in controlling the movement of a closure, the device comprising:
first and second magnetic elements spaced apart from each other;
a movable element such as a keeper element, preferably arranged relative to the magnetic elements, the movable element being movable between first and second holding positions wherein in the first holding position the movable element is held by a magnetic force of the first magnetic element and in the second holding position the movable element is held by a magnetic force of the second magnetic element; and
means for releasing the movable element from one of the holding positions, the released movable element moving to the other holding position,
the device being such that the movement of the closure can be controlled in dependence on the position of the movable element.

2. The device according to claim 1, wherein the device is adapted for interaction with an element of an apparatus for controlling the movement of a closure.

3. The device according to claim 1, wherein the device includes means for controlling the movement of the closure in dependence upon the position of the movable element.

4. The device according to claim 1 wherein the movement of the movable element is adapted to change the state of the device from a closure retaining state to a closure release state.

5. The device according to claim 1 wherein the closure is a door.

6. The device according to claim 1 wherein the movable element is arranged between the magnetic elements.

7. The device according to claim 1 wherein the magnetic element includes a permanent magnet.

8. The device as claimed in claim 7 wherein said permanent magnet is arranged to hold said movable element in said first or second holding position and wherein the movable element release means is operable to release said movable element from said first or second holding position by overwhelming said permanent magnet.

9. The device according to claim 1 wherein the magnetic element includes an electromagnet.

10. The device as claimed in claim 9 wherein said movable element is released from said first or second holding position when said electromagnet is energised.

11. The device according to claim 1 including means for applying a signal to an actuator to effect the release of the movable element.

12. The device according to claim 1, including means for applying a current to the magnet element to effect the release of the movable element.

13. The device as claimed in claim 12 wherein said current is applied for a period of time sufficient to release said movable element and wherein after said movable element is released said current is stopped.

14. The device as claimed in claim 1 wherein said movable element is retained in said first or second holding position without requiring the application of an electric current.

15. The device according to claim 1 wherein the magnetic elements and movable element are mounted in a common housing.

16. The device according to claim 1 wherein each of the first and second magnetic elements is associated with a separate actuator part.

17. The device according to claim 16 wherein said actuator parts are actuable independently of each other.

18-26. (canceled)

27. An apparatus for retaining a closure, including a catch device according to claim 1.

28. A door closer/retainer apparatus including a catch device according to claim 1.

29. A method of controlling the movement of a closure using a device comprising a closure movement apparatus for moving the closure from a first position to a second position, and retaining means for retaining the closure in one of the first and second positions, the device further including a catch according to claim 1, the method including the steps of:
identifying an alarm condition and
releasing the movable element from a holding position such that the released movable element moves to a holding position such that the retaining means releases the closure.

30-49. (canceled)
